(19) United States
(12) Patent Application Publication
(10) Pub. No.: US 2021/0396911 A1
(43) Pub. Date: Dec. 23, 2021

(54) MULTI-INJECTION MOLDED OPTICAL GRADE SILICONE LENS AND METHOD FOR PRODUCING INCORPORATING A GLOW IN THE DARK PHOSPHOR MATERIAL

(71) Applicant: Myotek Industries, Farmington Hills, MI (US)

(72) Inventors: Robert Herbert Miller, Canton, MI (US); Erik Lee Measel, Oxford, MI (US)

(21) Appl. No.: 17/351,462

(22) Filed: Jun. 18, 2021

Related U.S. Application Data
(60) Provisional application No. 63/040,799, filed on Jun. 18, 2020.

(51) Int. Cl. G02B 1/04; B29C 45/00; B29C 45/16; B60Q 1/04

(52) U.S. Cl. CPC G02B 1/041; B29C 45/0001; B29K 2083/005; B60Q 1/0408; B29C 45/16

(57) ABSTRACT

An optical grade injection molded lens and process for forming including injection molding a liquid silicone polymer material into a mold configuration to form a base component of the lens and incorporating a phosphorescent composition into the liquid silicone polymer. The phosphorescent composition occurs in either a single or multiple injection molding steps of the liquid silicone polymer. Additional injection molding steps provide for forming a decorative feature into the lens, as well as forming a colorized ring from a further injection molding of a liquid silicone polymer. The silicone optical lens is produced according to the process of the present invention is integrated into a lamp assembly including a housing and one or more illuminating elements which, upon being deactivated, provides the desired long term afterglow effect.

### CROSS REFERENCE TO RELATED APPLICATIONS

The present application claims the priority of U.S. Ser. No. 63/040,799 filed Jun. 18, 2020.

### FIELD OF THE INVENTION

The present invention relates generally to optics constructed of optical grade silicone. More particularly, the present invention discloses an article and mold process for forming an optical grade silicone lens by multiple shot injection molding steps and which incorporates a glow in the dark phosphoric composition. The multi-shot injection molded lens can be incorporated into any light transferring application not limited to fog lamps, headlamps, or any other lighting application which, upon turning off the lamp or illuminating source, provides for the phosphorescent material incorporated into the silicone lens to continue to glow for an extended period of time. Applications of the present invention can include without limitation automotive lighting, such as in order to create desired branding and styling variations. Additional safety applications are also envisioned.

### BACKGROUND OF THE INVENTION

The prior art is documented with examples of head lamp or other types of lighting devices utilizing a lens component. The prior art also discloses the use of glow in the dark phosphor materials integrated into various materials not limited to plastics and the like.

Among the prior art are references which combine aspects of these individual teachings, a first of these being had with reference to US 2019/0331321 to Tepo et al, and which teaches a light fixture includes a flexible shroud, an outer housing, and a light source within a light engine. The light engine couples within the outer housing so as to define a gap between the light engine and an inner perimeter of the outer housing. The flexible shroud forms at least first and second edge portions so that the light engine couples with the first edge portion, and the inner perimeter of the outer housing couples with the second edge portion, so that the flexible shroud covers at least part of the gap. A shroud for a light fixture may include a flexible shroud that defines one or more edges. The shroud may include one or more coupling features along the one or more edges. The flexible shroud may form a thickness variation at the coupling feature, to engage a corresponding coupling feature of a light fixture.

U.S. Pat. No. 5,717,282, to Oomen et al., teaches a display device including a display screen provided with phosphors, and coated with a spectrally selective, light-absorbing coating comprising silicon oxide and at least two dyes. The spectral transmissions for blue, green and red phosphor light are chosen to be such that the electron currents towards the blue, green and red phosphors for obtaining white D (6,500K) are substantially equal.

U.S. Pat. No. 6,375,864 to Phillips et al. discloses a molded, extruded or formed phosphorescent plastic article phosphorescent phosphor pigments that emit light in the visible spectrum, in combination with polymer-soluble daylight fluorescent dyes, in transparent or translucent resins. The plastic articles exhibit fluorescent daylight color and a glow-in-the-dark luminescence having a color similar to that of the daylight color.

U.S. Pat. No. 6,911,771 to Conrady discloses a fluorescent film for use with a low-pressure discharge lamp formed as a silicone elastomer in which luminescent particles are embedded. The film is formed by the steps of (a) mixing a hydroxyl polydiorganosiloxane with an organohydrogen siloxane. (b) adding luminescent particles, and (c) generating a chemical reaction by means of a platinum catalyst at room temperature.

Finally. US 2009/0315447 to Appel et al., teaches a light source, especially a fluorescent lamp, including at least one bulb, a silicon rubber which is resistant to high temperatures being arranged on the bulb. The silicon rubber is provided with at least one pigment influencing the color appearance and light saturation in order to generate a saturated color appearance.

### SUMMARY OF THE PRESENT INVENTION

The present invention discloses an article and process for forming an optical grade injection molded lens, including the steps of providing a molding assembly defining at least one interior mold configuration corresponding to desired dimensions of the lens, injection molding a liquid silicone polymer material into the mold configuration to form a base component of the lens, and incorporating a phosphorescent composition into the liquid silicone polymer. Additional steps include the incorporating of the phosphorescent composition occurring in either a single or multiple injection molding steps of the liquid silicone polymer.

Additional injection molding steps can be provided for forming a decorative feature into the lens, as well as forming a colorized ring from a further injection molding of a liquid silicone polymer. A silicone optical lens is produced according to the process of the present invention.

### BRIEF DESCRIPTION OF THE DRAWINGS

Reference will now be made to the attached drawings, when read in combination with the following detailed description, wherein like reference numerals refer to like parts throughout the several parts, and in which:

FIG. 1 is an illustration of a multi shot optical grade silicone lens produced according to the multi-shot process of the present invention, and such as which can include first and second differently colorized areas;

FIG. 2 is an illustration of a modification of an optical grade silicone lens produced according to a further variant of the present invention, shown inverted from FIG. 1, and which teaches a further injection molding step for forming an optional further colorized (black) ring into the silicone lens body;

FIG. 3 is a further plan view of the lens shown in FIG. 2;

FIG. 4 is an illustration of the lens in FIGS. 2-3, such as which can be utilized with an illuminating lamp source which, when turned off, provides for a phosphorescent illumination contained within a second stage injection molded material as revealed in a darkened environmental condition;

FIG. 5 is a cutaway view of an injection molded optical grade lens according to a non-limiting variant of the present invention and incorporating each of clear and phosphor impregnated areas, this in combination with an illuminating lamp support base about which the recessed underside of the lens body can be resistively fitted;

FIG. 6 is an assembled view of a lamp assembly incorporating an afterglow style of silicone lens according to a further non-limiting embodiment incorporated into a lamp assembly;

FIG. 7 is an exploded view of the lamp assembly shown in FIG. 7; and

FIG. 8 is an illustration of the silicone long persistent lens of FIG. 7.

### DETAILED DESCRIPTION OF THE PREFERRED EMBODIMENTS

With reference to the attached embodiments, the present invention discloses an article and mold process for forming an optical grade silicone lens by multiple shot injection molding steps and which incorporates a glow in the dark phosphoric composition. The multi-shot injection molded lens can be incorporated into any light transferring application not limited to fog lamps, headlamps, or any other lighting application which, upon turning off the lamp or illuminating source, provides for the phosphorescent material incorporated into the silicone lens to continue to glow for an extended period of time. Applications of the present invention can include without limitation automotive lighting, such as in order to create desired branding and style differentiations. Additional safety applications are also envisioned.

As is known, light can be defined as electromagnetic radiation which has different frequencies and wavelength. The spectrum that can be picked up by the retina of a human eye is called visible light. Materials through which light can refracted, reflected, transmitted, dispersed, polarized, detected and transformed are called optical materials.

The number of optical materials has expanded recently. In the past, glass and other ceramic materials were the few materials available that offered the best refractive index values. In the instance of glass specifically, the chemical structure is formed by Silicon (Si) and Oxygen (O) with low-range arrangement. The atoms in glass are arranged randomly, and because of this structure, glass is transparent. Conversely, metals have an organized structure and therefore are not transparent.

In glass, photons (the elementary particles that form the light) are able to pass through glass without interacting with any atom. Because of this structure, it has low mechanical properties and high density (between 2.3 and 6.3 g/cm³), which can be considered a disadvantage.

Some polymers have innate properties similar to glass, but they have low physical properties. Examples of some of these polymers include the thermoplastic materials Polycarbonate (PC), and Polymethyl Methacrylate (PMMA) that are processed using injection molding, along with Epoxy resins (EPI) and thermoset materials that are compression molded. These thermoplastic and thermoset materials have advantages, including high quality surfaces reflecting the mold surface, are easily processed, and available in a variety of grades with a wide range of properties. There are disadvantages as well, including thermal stability properties which are low compared to glass.

Optically clear grades of liquid silicone rubber polymers (also LSR's) offer advantages over both glass and thermoplastic and thermoset optical polymers. The chemical structures of liquid silicone rubber and glass have elements in common. Like glass, liquid silicone rubber is also formed by Si and O, however the additional radicals in its structure are what make silicone rubbers opaque or translucent by nature. Although common in some regards, the mechanical and physical properties of liquid silicone rubber are superior to glass and carbon-based polymers. In relation to hardness, LSR's can be as flexible as 5 Shore A, or as hard as glass (approximately 90 Shore A). Its density is also a plus, it ranges between 1.1 and 2.3 g/cm³, significantly lower than glass.

Most applications specifying optical materials will be in high temperature environments. Because of LSR's good thermal stability, optically clear Liquid Silicone Rubber performs well and maintains its transparency without decreasing over time. Thermoset epoxy resins for example do not perform well, their clarity decreases and will turn black when subjected to 200° C. for 200 hours.

In contrast, LSRs offer advantages over polycarbonates as well, as the optical LSR material will maintain homogeneous light distribution over a range of wavelengths, whereas when polycarbonate is used at specific wavelengths, it will turn yellow. Most applications using optical grade silicone center on highly precise geometries that are almost impossible to fabricate with current materials and methods, and the low viscosity before cure makes molding optical grade silicone into complex shapes easier than with either glass or organic polymers.

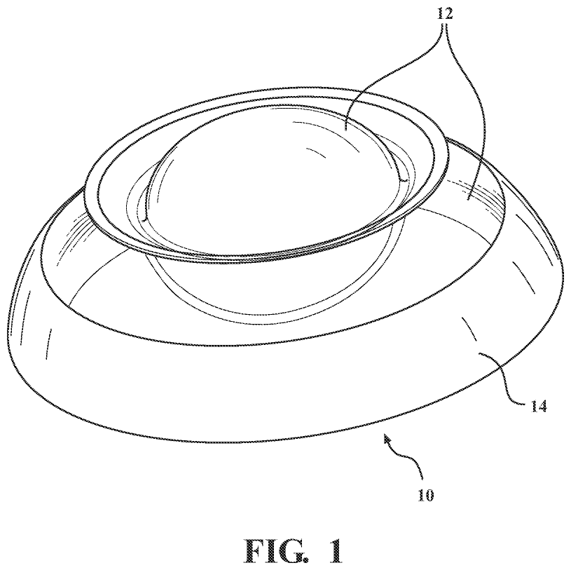

Applying the teaches of optical grade silicone, FIG. 1 is an illustration of a multi shot optical grade silicone lens produced according to the multi-shot process of the present invention. Although not shown, the present invention incorporates a suitable injection molding machine with openable and close-able mold halves for forming the optical grade lens from the liquid silicone rubber material and this can include the use of any of die slide or pick-and-place mechanisms for simultaneously and repetitively producing multiple iterations of the optical lens through multi-stage injection molding processes.

A first example of the multi-shot injection molded silicone lens is depicted at 10 in FIG. 1 and a further example is shown at 100 in each of FIGS. 2-4. FIG. 5 is a cutaway view of an injection molded optical grade lens, such as depicted in FIG. 1 again at 10 according to a non-limiting variant of the present invention and incorporating each of clear 12 and phosphor impregnated (also colorized) 14 areas, this in combination with an illuminating lamp support base, see as shown at 16 in FIG. 5, and about which the recessed underside of the lens body can be resistively fitted. To this end, the configuration of the inner mold (such as associated with the lower mold half) incorporates a suitable projection geometry for configuring the arcuate underside of the first shot injection molded lens base (e.g. the first shot material 12) formed from the injected silicone material. This is further illustrated in the cutaway of FIG. 5 by interconnected and underside configured edges 18 and 20, these being configured according to any profile for seating (such as resistively or through the use of adhesives) the lamp base 16, this in turn incorporating any type of illuminating element not limited to any of incandescent, LED or other source of illumination.

Other formation processes can include utilizing urethane material in a Reaction injection molding (RIM) process to manufacture plastic molded parts. In such a process, the urethane or other thermosetting polymers are mixed in a mixing device in a fluid state and then injected as a liquid mass into a mold and allowed to expand and cure therein. Reaction injection moldings have many benefits, including low tooling costs, short lead-times, large lightweight parts, high tolerances, enhanced design finish, and desired chemical resistance properties.

Referencing again FIG. 1, the multi-shot silicone lens 10 again contemplates a multi-shot injection molding process for forming the optical grade lens and which can include a first shot for providing a clear liquid silicone 12 for forming the lens base, this succeeded by a second shot 14 for forming such as the outer silicone rim (this again usually including a colorized phosphor). Without limitation, the present invention contemplates the utilization of any type of phosphoric composition, such as which is provided in either of a liquid or powder form which is intermixed or entrained within the second shot liquid silicone in order to provide a desired glowing colorization upon being irradiated by the lamp illumination source 16. It is also envisioned that the silicone construction of the lens can additionally incorporate any ingredients or components for forming the lens material in any of a rigid, semi-rigid or flexible composition, depending upon the envisioned application.

Without limitation, common pigments used in phosphorescent materials include zinc sulfide and strontium aluminate and which can be provided in a number of colors, not limited to blue, yellow, red and green. Strontium Aluminate based luminous materials can also be doped with the rare earth mineral Europium and can re-charge limitless times by light and emit an afterglow for hours without the need of any UV lighting.

FIG. 2 is an illustration of the modification of optical grade silicone lens, again at 100, produced according to a further variant of the present invention and which, additional to the first shot injection molding step for forming the clear lens base 102 and the second shot 104 for forming the phosphorous pigmented outer rim portion, teaches a further, typically third, injection molding step for forming an optional black or other third colored ring 106 into the silicone lens body. The third injection molding step is envisioned to include, in one non-limiting embodiment, a black pigment incorporated into the silicone material as a further design feature and which, as shown, can be located at an interface between the first shot clear material 102 and the subsequent outer rim shot of phosphorescent colorized material 104. It is also envisioned that the third shot material can alternatively include any other colorant which can be envisioned to also include a second phosphorescent or non-phosphorescent composition.

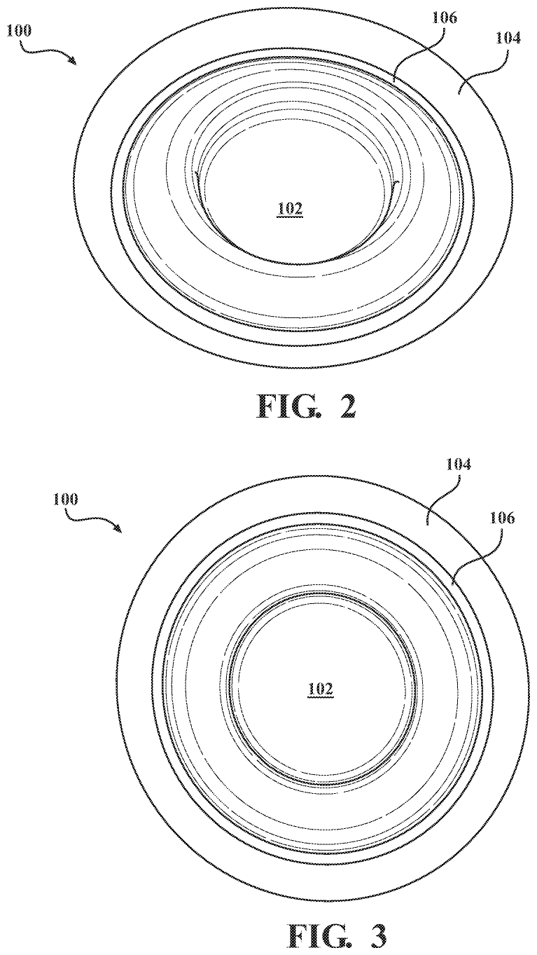

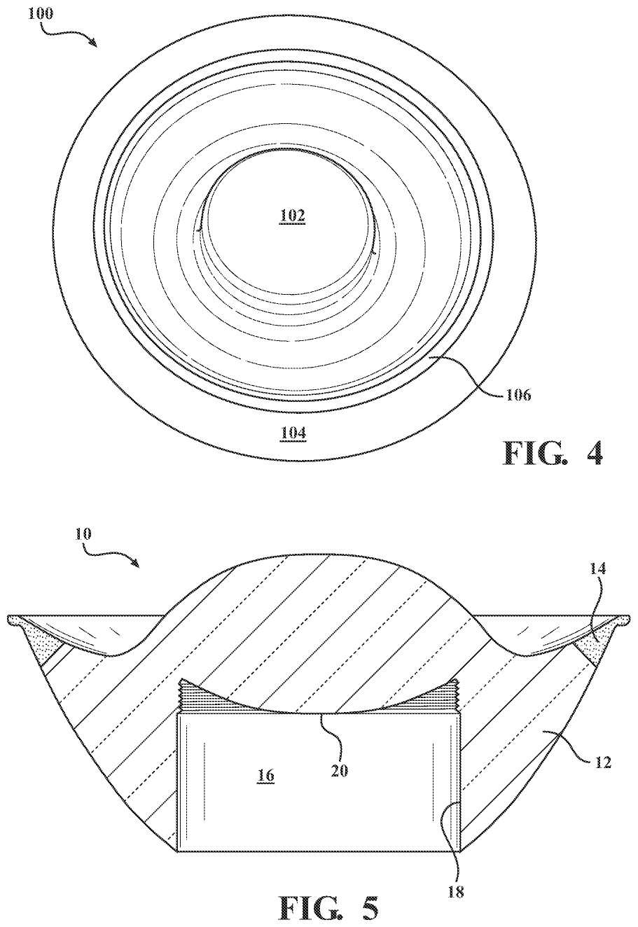

FIG. 3 is a further view of the lens shown in FIG. 2 viewed from another angle and which can be produced within a suitably configured mold assembly, such as which can be configured to produce in quantity the afterglow optic lenses disclosed herein. FIG. 4 is an illustration of the lens 100 in FIGS. 2-3 and such as, upon the illuminating lamp source being turned off, provides for a selected phosphorescent illumination (not limited to any colorized phosphor) of the second injection molded material 104 which is emitted in a darkened environmental condition in order to provide long persistent afterglow functionality.

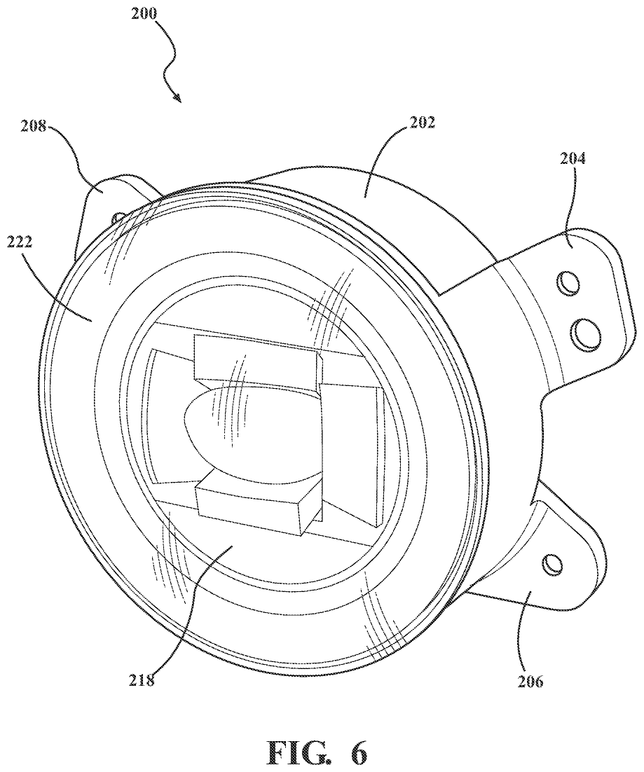

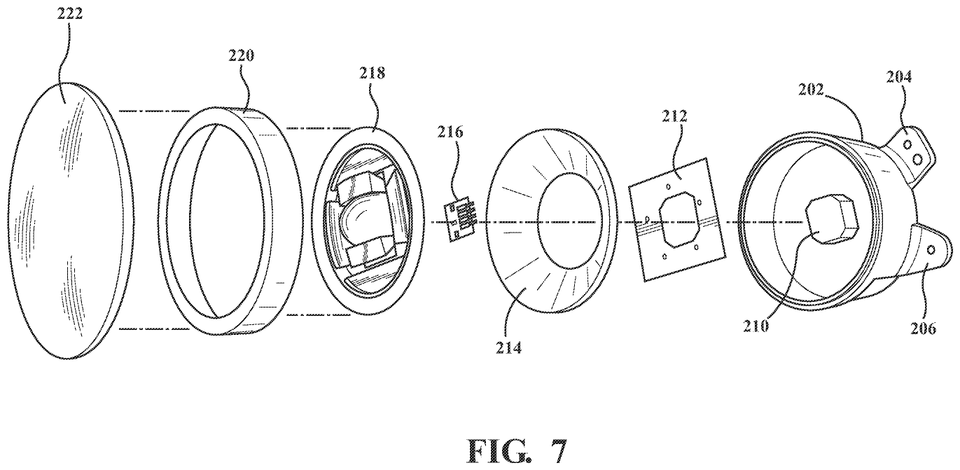

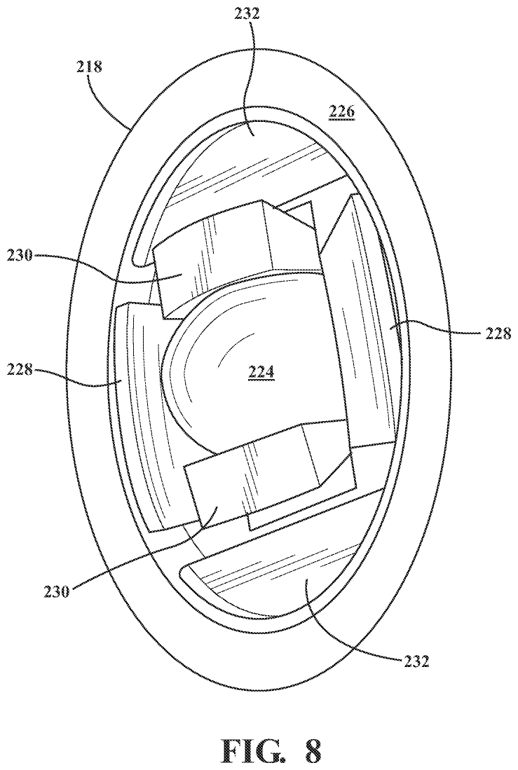

Proceeding to FIGS. 6-7, a pair of assembled and exploded views are shown, at 200, of a lamp assembly providing an afterglow style of silicone lens according to a further non-limiting embodiment incorporated into a lamp assembly. Components of the assembly include a bowl shaped base housing 202 with a plurality of radially extending wings or ears 204, 206 and 208 for securing to a suitable location, such as a vehicle front or rear. A recessed interior of the bowl shaped profile of the base housing 202 also includes a polygonal shaped projection 210, such as which can receive a placard shaped template 212 with a cutout for seating over the projection 210.

A tapered and ring shaped shielding or reflector component 214 seats upon the template 212. A processor (also a PCBA) component 216, such as incorporating any number of LED or like illuminating components, is powered by one or more separate lines in the vehicle (not shown) and is integrated into a base of a lamp-style silicone lens 218 which, upon being seated upon the base housing projection 210, overlays the PCBA with LED elements.

Other components include a three dimensional retaining ring 220 with an outer annular profile which mates with an outer annular rim of the base housing 202 in a manner which biases an injection molded outer annular skit of the silicone lens 218 therebetween. An outer rigid protective lens covering 222 is provided which can be produced from any transparent material and which installs upon the outer retaining ring 220 in order to protect the interior supported silicone lens 218 and other components of the assembly.

FIG. 8 is an illustration similar of the silicone long persistent lens 218 of FIG. 7 and which, as previously described in reference to the lenses 10 and 100, can be provided according to any multi-shot injection molded construction including each of a first shot clear silicone (see at 224), as well as a second shot silicone incorporating a phosphor colorant (such as at outer ring corresponding to 226 in FIG. 8). Without limitation, the colorized pigmentation incorporated into the second shot silicone lens material can be provided according to any desired styling or branding particular to a specific vehicle make or model.

As previously described, the pigmentation provides any desired long term after glow persistence, such as following deactivation of the LED or like illuminating components incorporated into the PCBA 216. Depending upon the phosphor composition incorporated into the second shot silicone materials, such long-persistent afterglow effect can last for an extended period of time, such as up to several hours following the deactivation of the primary LED illumination from the PCBA component 216.

As further shown in FIG. 8, the design of the silicone lens 218 can further include different areas for providing alternate illuminating options. Additional to the central, clear and bulbous shaped portion (again at 224) and the second shot outer pigmented ring (again at 226), the lens can include other configures areas including respective pairs of side 228, upper/lower 230 and top/bottom 232 areas which can be constructed from either a first shot clear silicone or second shot phosphor pigmented silicone material. The design of the silicone lens, in combination with the tpe and arrangement of the LED's incorporated into the PCBA illuminating component 216 can further provide each of primary and fog-lamp style illumination according to the desired application.

A corresponding process for forming an optical grade injection molded lens, includes the steps of providing a molding assembly defining at least one interior mold configuration corresponding to dimensions of the lens, injection molding a liquid silicone polymer material into the mold configuration to form a base component of the lens, and incorporating a phosphorescent composition into the liquid silicone polymer.

Other process steps include incorporating the phosphorescent composition occurring in either a single or multiple injection molding steps of the liquid silicone polymer. An additional injection molding step can be provided for forming a decorative feature into the lens. The step of forming a colorized (usually outer) ring can include a further injection molding of a liquid silicone polymer.

Having described my invention, other and additional preferred embodiments will become apparent to those skilled in the art to which it pertains, and without deviating from the scope of the appended claims. This can include, without limitation, the phosphorescent entrained material being admixed into the liquid silicone (LSR) material and applied in other injection molding steps or techniques which can include reconfiguring the mold delivery channels and interior defining surfaces to incorporate the phosphorescent compounds according to varying designs.

In this manner, the multiple shot molded article and molding assembly/techniques described herein can be modified to accommodate other shapes or profiles. It is further envisioned and understood that the phosphorescent material can be provided according to any variety of colors or compositions, this including co-injecting individual phosphorescent compositions via individual injection molding channels in a given shot application or the successive injection molding of different phosphorescent compositions in succeeding molding steps.

The detailed description and drawings are further understood to be supportive of the disclosure, the scope of which being defined by the claims. While some of the best modes and other embodiments for carrying out the claimed teachings have been described in detail, various alternative designs and embodiments exist for practicing the disclosure defined in the appended claims.

The foregoing disclosure is further understood as not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, a person of ordinary skill in the art will recognize that changes may be made in form and detail without departing from the scope of the present disclosure. Thus, the present disclosure is limited only by the claims.

In the foregoing specification, the disclosure has been described with reference to specific embodiments. However, as one skilled in the art will appreciate, various embodiments disclosed herein can be modified or otherwise implemented in various other ways without departing from the spirit and scope of the disclosure. Accordingly, this description is to be considered as illustrative and is for the purpose of teaching those skilled in the art the manner of making and using various embodiments of the disclosure. It is to be understood that the forms of disclosure herein shown and described are to be taken as representative embodiments. Equivalent elements, materials, processes or steps may be substituted for those representatively illustrated and described herein. Moreover, certain features of the disclosure may be utilized independently of the use of other features, all as would be apparent to one skilled in the art after having the benefit of this description of the disclosure. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

Further, various embodiments disclosed herein are to be taken in the illustrative and explanatory sense, and should in no way be construed as limiting of the present disclosure. All joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other.

Additionally, all numerical terms, such as, but not limited to, “first”, “second”, “third”, “primary”, “secondary”, “main” or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It will also be appreciated that one or more of the elements depicted in the drawings/figures can also be implemented in a more separated or integrated manner, or even removed or rendered as inoperable in certain cases, as is useful in accordance with a particular application. Additionally, any signal hatches in the drawings/figures should be considered only as exemplary, and not limiting, unless otherwise specifically specified.

We claim:

1. A process for forming an optical grade injection molded lens, comprising the steps of:
providing a molding assembly defining at least one interior mold configuration corresponding to dimensions of the lens;
injection molding a liquid silicone polymer material into the mold configuration to form a base component of the lens; and
incorporating a phosphorescent composition into the liquid silicone polymer.

2. The process according to claim 1, further comprising the step of incorporating the phosphorescent composition occurring in either a single or multiple injection molding steps of the liquid silicone polymer.

3. The process according to claim 2, further comprising an additional injection molding step for forming a decorative feature into the lens.

4. The process according to claim 3, further comprising the step of forming a colorized ring from a further injection molding of a liquid silicone polymer

5. A vehicle lamp assembly, comprising:
a base housing;
a reflecting and shielding element incorporated into a recessed interior of said base housing;
an injection molded silicone lens supported within said housing upon said shield element and incorporating a circuit board having one or more illuminating elements; and
said lens having each of a clear portion and a phosphor impregnated pigmented portion such that, and upon deactivation of said illuminating elements, said phosphor pigmented portion continues glowing for an extended period of time.

6. The vehicle lamp assembly of claim 5, said base housing further comprising a bowl shape with a plurality of radially extending wings or ears for securing to a of the vehicle.

7. The vehicle lamp assembly of claim 5, said base housing further comprising a polygonal shaped projection, such as which can receive a placard shaped template with a cutout for seating over said projection.

8. The vehicle lamp assembly of claim 5, further comprising a tapered and ring shaped shielding or reflector component seating upon said template.

9. The vehicle lamp assembly of claim 5, said circuit board further comprising a PCBA processor component.

10. The vehicle lamp assembly of claim 9, said illuminating elements further comprising any number of LED or like illuminating components powered by one or more separate lines in the vehicle.

11. The vehicle lamp assembly of claim 9, further comprising a three dimensional retaining ring with an outer annular profile which mates with an outer annular rim of said base housing in order to bias an injection molded outer annular skit of said molded silicone lens therebetween.

12. The vehicle lamp assembly of claim 11, further comprising an outer rigid protective lens covering produced from any transparent material and which installs upon said retaining ring.
